(19) United States
(12) Patent Application Publication
(10) Pub. No.: US 2011/0284388 A1
(43) Pub. Date: Nov. 24, 2011

(54) Resin Plating Method Using Graphene Thin Layer

(75) Inventors: Ah Hyun Bae, Hwaseong-si (KR); Sang Ik Son, Suwon-si (KR); Jae Do Nam, Suwon-si (KR); Jun Ho Lee, Suwon-si (KR); Tae Seon Hwang, Suwon-si (KR); Joon Suk Oh, Suwon-si (KR)

(73) Assignee: SAMSUNG ELECTRONICS CO., LTD., Suwon-si (KR)

(21) Appl. No.: 13/078,123

(22) Filed: Apr. 1, 2011

(30) Foreign Application Priority Data
May 18, 2010 (KR) 10-2010-0046626

(51) Int. Cl. C25D 5/54; B82Y 99/00; B82Y 40/00

(52) U.S. Cl. 205/164; 977/734; 977/890

(57) ABSTRACT

According to an example embodiment a method of plating resin using a graphene thin layer includes forming a graphene thin layer on a resin substrate and electroplating the resin substrate having the graphene thin layer fog on the resin substrate.

### CROSS-REFERENCE TO RELATED APPLICATION

This application claims priority under 35 U.S.C. §119 to Korean Patent Application No. 2010-046626 filed on May 18, 2010 with the Korean Intellectual Property Office, the entire disclosure of which are incorporated herein by reference.

### BACKGROUND

1. Field

Example embodiments relate to a method of plating resin with use of a graphene thin layer and, more particularly, to a resin plating method using a graphene thin layer which includes forming the graphene thin layer on a resin substrate, and electroplating the resin substrate having the graphene thin layer formed thereon.

2. Description of the Related Art

Recently pursued goals in applications of electronic equipment and/or automobile components are to improve appearance and reduce weight thereof. For weight reduction of a product, an injection-molded resin is generally used instead of metal since it advantageously allows easy formation of a complicated shape difficult to manufacture using metal. However, such molded resin lacks rigidity as well as visual appearance and needs surface treatment. In this case, spray painting and plating are generally employed.

A typical resin plating technique includes forming microfine holes on a surface of a non-conductive resin by etching, laminating a conductive film thereon, and electrochemically forming a metal film with excellent durability over the laminate. As a result, the injection-molded plastic obtained by the foregoing technique has the appearance of metal. However, in order to form microfine holes on the surface of the plastic, severe conditions including use of strong acid and base are required. In other words, since the plating process is a surface treatment technique performed in a fixed place and must use strong base and acid in large quantities, productivity is reduced due to problems of waste water and plural plating processes. Further, types of resin capable of undergoing resin plating are limited. That is, resin plating may be limitedly used for acrylonitrile butadiene styrene copolymer (hereinafter, referred to as ‘ABS’) containing rubber moiety that can be etched using strong acid and base, and the like, in turn having poor selectivity for types of resin. In addition, chromic acid and sulfuric acid used for etching are unsuitable for wastewater treatment and are dangerous to a worker's health. In order to comply with recent environmental regulations, hexavalent chromium is now being replaced with trivalent chromium and, instead of Ni, nickel (Ni)-safe and/or Ni-free type plating is introduced. However, these are not considered as a fundamental solution to overcome environmental problems entailed in plating techniques.

Accordingly, example embodiments describe a novel and eco-friendly plating process of decreasing the number of individual processes in existing multi-stage plating methods. In order to embody the foregoing novel plating process, graphene is used. Etching used in any conventional plating method is a process to physically adhere and combine a resin with a plating film. However, since the resin does not have conductivity by such etching process, an alternative process to impart conductivity to the resin is required (see FIG. 1). In contrast, according to an example embodiment, an eco-friendly plating method which includes use of graphene having high adhesion to a resin as well as high conductivity, so as to considerably reduce the number of individual processes in etching and activation stages and to enable formation of a plating film, are disclosed.

### SUMMARY

According to an example embodiment, a resin plating method includes forming a graphene thin layer on a resin substrate, and electroplating the resin substrate having the graphene thin layer formed thereon.

According to an example embodiment, forming the graphene thin layer includes applying a graphene oxide dispersion to the resin substrate, and reducing the graphene oxide coating.

According to an example embodiment, the method further includes forming amine groups on a surface of the resin substrate before coating the resin substrate with the graphene oxide dispersion.

According to an example embodiment, the forming amine groups generates the amine groups by plasma treatment using a gas selected from a group consisting of a gas mixture of Ar and N2, a gas mixture of H2 and N2, and NH3.

According to an example embodiment, forming the graphene thin layer includes applying an expanded graphite dispersion to the resin substrate.

According to an example embodiment, the method further includes filtering the expanded graphite dispersion, and applying the filtered expanded graphite dispersion to the resin substrate by a wet transfer process.

According to an example embodiment, the method further includes copper plating the resin substrate that has the graphene thin layer formed thereon.

According to an example embodiment, the method further includes electroplating the resin substrate obtained after the copper plating using at least one metal selected from a group consisting of Ni, Cu, Sn and Zn.

According to an example embodiment, the method further includes electroplating the graphene thin layer using at least one metal selected from a group consisting of Ni, Cu, Sn and Zn.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 shows a resin plating process according to an example embodiment, compared to a related art resin plating method;

FIG. 2 is a schematic view illustrating a wet transfer process of expanded graphite; and

FIG. 3 shows measured results of surface roughness and thickness of a graphene thin layer formed according to an example embodiment, using an atomic force microscope (AFM).

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved

According to an example embodiment, a method for plating a resin, includes: forming a graphene thin layer over a resin substrate and electroplating the resin substrate coated with the graphene thin layer.

A graphene thin layer may be formed by applying a graphene oxide dispersion to the resin substrate and reducing the graphene oxide coating.

The term “graphene oxide” refers to an oxide obtained by oxidizing graphite and, since polar groups exist on a surface of the graphene oxide, this graphene oxide exhibits “hydrophilicity.” In contrast to graphite, the graphene oxide may be prepared into a dispersion and be formed into a thin layer.

However, the graphene oxide is an electrically insulating substance and must undergo reduction in order to recover electric conductivity thereof. After a graphene oxide thin layer is formed on the resin using a graphene oxide dispersion, the formed thin layer is subjected to reduction to produce a sheet type graphene. The term “reduction of graphene oxide” means that the graphene oxide undergoes reduction to impart electrical conductivity thereto.

The term “graphene” refers to a polycyclic aromatic molecule formed by covalent bonding of multiple carbon atoms and, in general, such carbon atoms covalently bonded together form a six (6)-membered ring as a repeating unit, although a 5-membered ring and/or 7-membered ring may also be included. Therefore, graphene may comprise a single layer of covalently bonded carbon atoms (typically SP² bond) or may faun a laminate of multiple layers wherein the laminate may have a maximum thickness of 100 nm. Moreover, the graphene may have different structures which vary depending on content of 5-membered and/or 7-membered rings.

An example of a process for formation of a thin layer using graphene oxide in a reduced state may comprise: oxidizing graphite to generate graphene oxide and dispersing the graphene oxide in a solvent to prepare a dispersion; applying the dispersion to a resin and drying the coated resin; immersing the dried resin in a solution containing a reducing agent for a desired time and reducing the graphene oxide, in order to prepare a reduced graphene oxide; and forming a thin layer of the reduced graphene oxide on a resin substrate.

In this regard, a process for formation of graphene oxide may include, for example, the Staudenmaier method (Staudenmaier L. Verfahren zurdarstellung der graphitsaure, Ber Dtsch Chem Ges 1898, 31, 1481-99), Hummers method (William S. Hummers. Jr., Richard E. Offeman, Preparation of graphite oxide, J. Am. Chem. Soc., 1958, 80(6), p. 1339), Brodie method (Brodie B C, Sur le poids atomique du graphie, Anm Chim Phys 1860, 59, 466-72), etc., the disclosures of which are incorporated herein by reference.

By applying the graphene oxide dispersion prepared as described on the resin substrate and drying the same, a graphene oxide thin layer is formed over the resin substrate. Application of the graphene oxide dispersion to the resin substrate may be performed by coating method including, for example, dip coating, drop coating, spray coating, or the like.

The graphene oxide dispersion may be prepared by adding a solvent to graphene oxide, sonicating the mixture to disperse the graphene oxide in the solvent, and separating unoxidized graphite through centrifugation. The solvent depends on types of resin and may include, for example, deionized water (DIW), acetone, ethanol, 1-propanol, dimethyl sulfoxide (DMSO), pyridine, ethylene glycol, N,N-dimethyl formamide (DMF), N-methyl-2-pyrrolidone (NMP), tetrahydrofuran (THF), and the like.

A process of reducing of graphene oxide is disclosed in, for example, Carbon 2007, 45, 1558, Nano Letter 2007, 7, 1888, the disclosures of which are incorporated herein by reference. A reducing agent used herein is not particularly limited but may include, for example, NaBH₄, N₂H₂, LiAlH₄, TBAB, ethylene glycol, polyethylene glycol, Na, and the like.

In addition, before coating the resin substrate with the graphene oxide dispersion, amine groups may be formed on a surface of the resin substrate.

As described above, since the graphene oxide dispersion is hydrophilic, if a surface of the resin substrate becomes hydrophilic by surface treatment before applying the graphene oxide dispersion to the resin substrate, dispersibility of graphene oxide above the resin substrate may be improved. Amine groups may be formed on a surface of the resin substrate in order to conduct surface treatment of the resin substrate, in turn imparting hydrophilic properties to the resin substrate.

In this regard, amine groups may be generated by plasma treatment using a gas selected from a gas mixture of Ar and N₂, a gas mixture of H2 and N2, and NH3, for example.

The resin substrate having a reduced graphene oxide thin film formed thereon may undergo chemical copper plating. In this case, the copper plated resin substrate may further be plated by electroplating using at least one metal selected from a group consisting of Ni, Cu, Sn and Zn.

The resin substrate having a reduced graphene oxide thin film (for example, a graphene thin layer) formed wed thereon may directly undergo electroplating using at least one metal selected from a group consisting of Ni, Cu, Sn and Zn without copper plating.

The graphene thin layer may be formed by applying an expanded graphite dispersion solution to the resin substrate.

In this case, the expanded graphite dispersion solution may be applied to the resin substrate by a wet transfer process, for example.

A graphite laminate of multiple layers may be used for preparation of expanded graphite. For example, a graphite intercalation complex comprising an insert material between layers is generated by acid treatment of graphite and formed into the expanded graphite by heat treatment at a high temperature (500° C. or more). Alternatively, the expanded graphite may be prepared using SO₃ gas, concentrated sulfuric acid and a strong oxidant. Stated otherwise, a graphite intercalation compound may be formed into expanded graphite by thermal decomposition in a “thermal shock” system. In this case, examples of the graphite intercalation compound that may be used herein include acetic anhydride, sulfuric acid, and the like.

Graphite is a homologue of carbon, consists of covalently bound carbon atoms, and has a lamellar (or layered) structure. Separate layers of the graphite are parallel to one another and interlayer bonding of these layers by van der Waals force is weaker than covalent bonding between carbon atoms. Because of such characteristics, different atoms or molecules may be intercalated between graphite interlayers so as to form an intercalation complex. Also, the layered compound may have a one (1) to five (5)-stage structure by chemical oxidation and according to the number of single carbon layers between intercalation layers comprising insert materials therein. By heat treatment of the produced intercalation complex, a gaseous insert material is evaporated and a relatively weak c-axis of graphite is expanded, in turn producing expanded graphite. The expanded graphite with porosity may be produced by acid and heat treatment of natural graphite in a lamellar structure.

By dispersing the expanded graphite formed as described above in a solvent, an expanded graphite dispersion is prepared. The solvent may include, for example, DIW, acetone, ethanol, 1-propanol, DMSO, pyridine, ethylene glycol, DMF, NMP, THF, and the like.

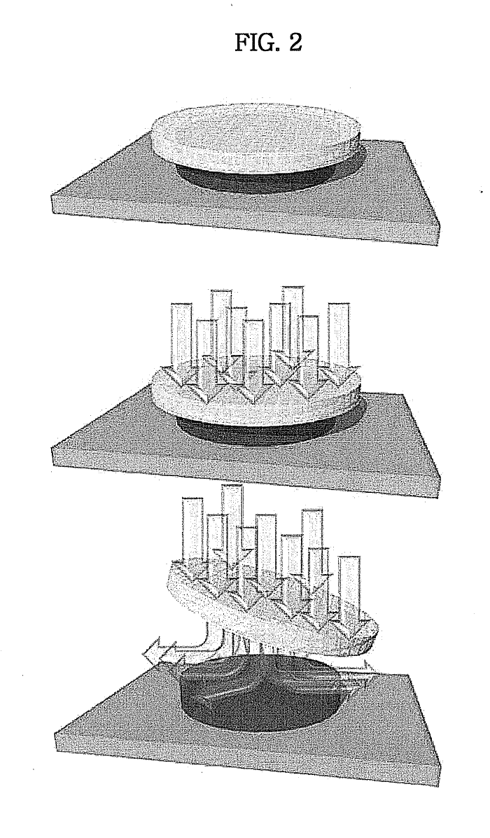

After the expanded graphite dispersed in the solvent is separated from the same through a filter, the separated graphite is added to DIW. Next, a graphene thin layer is formed by wet transfer in a DIW bath. The filter used herein may be a special filter for biochemical isolation of proteins. Alternatively, the filter may be a circular filter having a diameter of 47 mm. FIG. 2 schematically shows a method for wet transfer of expanded graphite.

A resin substrate having a graphene thin layer formed thereon may be subjected to copper plating. In this regard, at least one metal selected from a group consisting of Ni, Cu, Sn and Zn may be applied to the copper-plated resin substrate by electroplating.

A resin substrate having a graphene thin layer formed thereon may directly be subjected to electroplating using at least one metal selected from a group consisting of Ni, Cu, Sn and Zn, without copper plating.

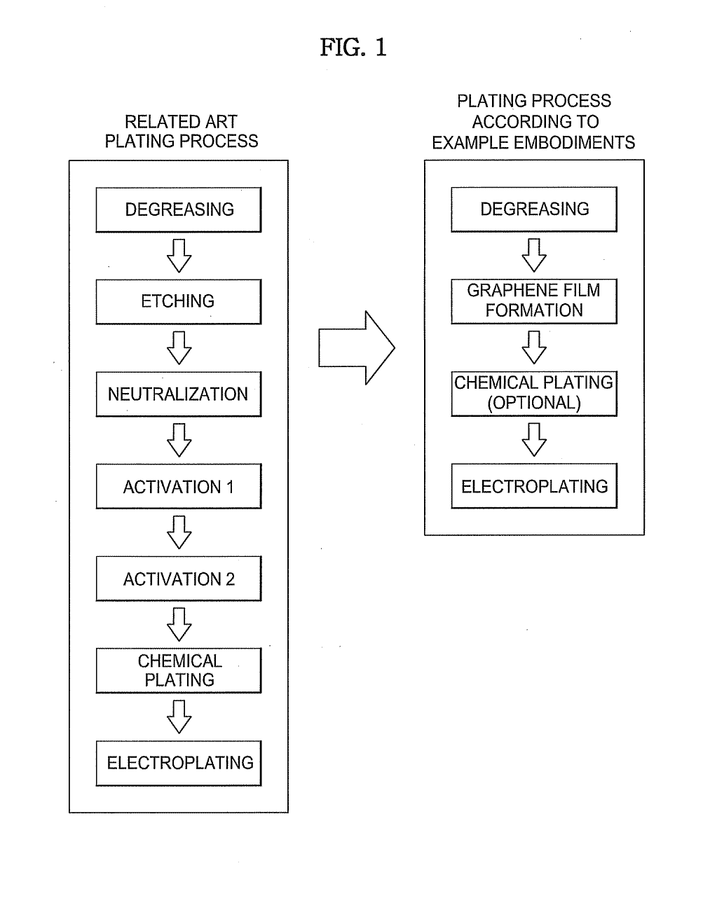

The resin used in example embodiments may include natural resin as well as synthetic resin. The term “resin” refers to an amorphous solid or semisolid substance including an organic compound and derivatives thereof and is classified into natural resin and synthetic resin. In an example embodiment, an etching process for plating is not required (see FIG. 1), therefore, compared to conventional techniques using strong acid and/or base that are employed in limited types of resin containing rubber moiety (for example, ABS), all type resins may be used. That is, all resins useful for embodying appearance of a product may be used.

### Preparative Example 1

(1) Pre-Treatment of Resin

A resin surface was treated to be hydrophilic and amine groups (NH₂) were formed on the surface by plasma treatment. Then, dropping water droplets over the surface, a contact angle test was performed to determine hydrophilicity.

(2) Preparation of Graphene Oxide (GO)

GO was prepared by Hummers method (William S. Hummers Jr., Richard E. Offeman, Preparation of graphite oxide, J. Am. Chem. Soc., 1958, 80(6), p 1339). That is, 10 g of natural graphite (Hundai Coma Co., Ltd., HC-590), 250 ml of H₂SO₄ and 5 g NaNO₃ were admixed, cooled in ice water, and maintained at 20° C. for 10 minutes. Thereafter, 30 g of KMnO₄ was slowly added to the mixture over 1 hour, followed by gradually raising the temperature to leave the mixture at 35° C. for 2 hours then cooling the same at room temperature. 450 ml of DI water was added thereto. In order to conduct reduction of residual KMnO₄, 2 L of DI water and 15 ml of 35% H₂O₂ were sequentially added to the mixture for 30 minutes, so as to complete the reaction. The obtained grapheme oxide was filtered and washed using 5% HCl (5L) once then using DI water three times to reach pH 7. Following this, the washed product was subjected to drying in a vacuum oven at 60° C. for 24 hours in order to remove the residual KMnO₄.

(3) Preparation of Graphene Oxide Dispersion

After adding 100 ml of DI water to 100 mg of graphene oxide prepared above, supersonic irradiation was performed for 4 hours, followed by centrifugation so as to remove residual graphite that was not transferred into graphene oxide.

(4) Reduction of Graphene Oxide

After dropping 200 μl of graphene oxide dispersion on a surface of ABS resin and PC resin with each size of 5 cm×5 cm, respectively, each of the obtained ABS resin and PC resin was immersed in a 50 mM NaBH₄ solution for 2.5 days for reduction of graphene oxide, thereby forming a reduced graphene oxide.

Otherwise, after dipping ABS resin and PC resin with each size of 5 cm×5 cm in 200 μl of graphene oxide dispersion, respectively, each of the obtained ABS resin and PC resin was immersed in 50 mM NaBH₄ solution for 2.5 days for reduction of graphene oxide, thereby forming a reduced graphene oxide.

(5) Electroless Copper Plating

A specimen having a graphene oxide thin film formed thereon was subjected to activation in an activating solution containing 10 to 15% of an active agent NP-8 for resin plating as well as 10 to 15% of hydrochloric acid at 35 to 40° C. for 5 minutes, followed by accelerated activation in 10% sulfuric acid solution at 40 to 45° C. for 2 minutes. Then, the activated specimen was dipped in an electroless copper plating solution with copper content of 2 to 3 g/L, EDTA content of 20 to 25 g/L, sodium hydroxide content of 5 to 6 g/L and formaldehyde content of 3 to 5 ml/L at 30 to 35° C. for 10 minutes, in turn forming an electroplating film required for plating. However, this process is optional.

(6) Electroplating

Using a mixture containing 200 to 250 g/L of copper sulfate and 30 to 35 ml/L of sulfuric acid in desired relative fractions, the specimen was copper polishing-plated with a current density of 3 to 5 A/dm² at 25 to 30° C. for 5 to 10 minutes.

### Preparative Example 2

(1) Preparation of Expanded Graphite

Natural graphite, KMnO₄ and HNO₃ were admixed in a mass ratio of 1:2:1 and the mixture was microwave irradiated for 30 seconds.

(2) Preparation of Expanded Graphite Dispersion

100 mg of the foregoing expanded graphite was mixed with 250 ml of n-methyl-2-pyrrolidinone (NMP) and dispersed using a sonicator.

(3) Formulation of Graphene Thin Layer

In order to form a graphene thin layer, vacuum filtration was performed using a circular filter with a diameter of 47 mm to isolate graphite dispersed in NMP from the same. After filtration, the product was dried at room temperature for 6 hours. The graphite separated from NMP was added to DI water in order to transfer the graphite into a graphene thin layer by wet transfer in DI water.

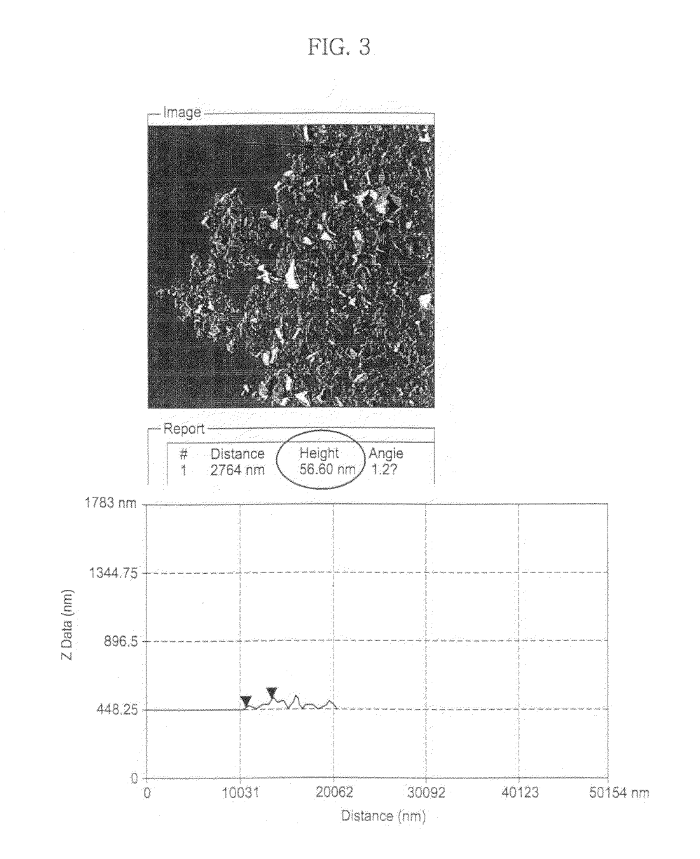

The graphite thin layer formed in Preparative Example 2 was subjected to measurement of surface roughness and thickness using AFM and the measured results are shown in FIG. 3. As shown in FIG. 3, the graphene thin layer with a thickness of 50 nm was formed.

Further following processes are substantially the same as the foregoing (5) and (6) in Preparative Example 1.

### Experimental Example

As to the resins having the graphene thin layers formed by the foregoing methods described in Preparative Examples 1 and 2, electrical conductivity was determined. The electrical conductivity was determined by a 4-point probe method. The 4-point probe method is characterized in that four different contact points are selected from plural contact points formed in a specimen at a constant interval and two inner contact points thereamong are connected to a voltage terminal while two outer contact points are connected to a current terminal, so as to measure volume electric resistivity of a certain measurement region.

Each specimen was measured twice at fixed 10⁻³ A and 10⁻² A.

Measured results are shown in TABLE 1 below.

TABLE 1

| Preparative | | | | Thickness | | | | d | | Sheet | Bulk | Sheet |
|---|---|---|---|---|---|---|---|---|---|---|---|---|
| Example | I | V | R | (cm) | t/s | Width (cm) | Length (cm) | (cm²) | d/s | resistance | resistance | conductivity |
| 1-1 | 1.E−03 | 2.E−01 | 175.12 | 5.E−06 | 5.E−05 | 0.600 | 0.500 | 0.300 | 3.000 | 210.144 | 4.382E−03 | 228.232 |
| 1-2 | 1.E−04 | 2.E−02 | 176.68 | 5.E−06 | 5.E−05 | 0.600 | 0.500 | 0.300 | 3.000 | 212.018 | 4.421E−03 | 226.215 |
| 1-3 | 1.E−03 | 2.E−01 | 174.81 | 5.E−06 | 5.E−05 | 0.600 | 0.500 | 0.300 | 3.000 | 209.772 | 4.374E−03 | 228.637 |
| 1-4 | 1.E−04 | 2.E−02 | 180.24 | 5.E−06 | 5.E−05 | 0.600 | 0.500 | 0.300 | 3.000 | 216.288 | 4.510E−03 | 221.749 |
| 2-1 | 1.E−03 | 1.E−01 | 129.53 | 5.E−06 | 5.E−05 | 0.700 | 0.600 | 0.420 | 4.200 | 151.118 | 3.151E−03 | 317.378 |
| 2-2 | 0.001 | 0.12922 | 129.22 | 5.E−06 | 5.E−05 | 0.700 | 0.600 | 0.420 | 4.200 | 150.757 | 3.143E−03 | 318.139 |
| 2-3 | 1.E−04 | 1.E−02 | 133.63 | 5.E−06 | 5.E−05 | 0.700 | 0.600 | 0.420 | 4.200 | 155.901 | 3.251E−03 | 307.641 |
| 2-4 | 1.E−04 | 134.05 | 134.05 | 5.E−06 | 5.E−05 | 0.700 | 0.600 | 0.420 | 4.200 | 156.390 | 3.261E−03 | 306.680 |

As listed in TABLE 1, it was found that the resin substrate exhibits electrical conductivity. Compared to conventional techniques, the method disclosed herein may enable direct metal plating of a resin without typical etching, activation and chemical nickel plating processes (see FIG. 1).

TABLE 1 shows that micro cracks may occur during formation of a graphene thin layer when R value in a curved side of the specimen is high. It is believed that surface treatment of the resin and/or transfer velocity is significant in enhancing transfer quality.

The graphene thin layer formed according to Preparative Examples 1 and 2 preferably has a thickness of 50 nm. However, when regulating an amount of graphene oxide or graphite in the dispersion, the thickness of the graphene thin layer and film quality may be improved.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A resin plating method, comprising:
forming a graphene thin layer on a resin substrate; and
electroplating the resin substrate having the graphene thin layer formed thereon.

2. The method according to claim 1, wherein the forming the graphene thin layer comprises:
applying a graphene oxide dispersion to the resin substrate to form a grapheme oxide coating; and
reducing the graphene oxide coating.

3. The method according to claim 2, further comprising:
forming amine groups on a surface of the resin substrate before applying a grapheme oxide dispersion to the resin substrate.

4. The method according to claim 3, wherein the forming amine groups generates the amine groups by plasma treatment using a gas selected from a group consisting of a gas mixture of Ar and N₂, a gas mixture of H₂ and N₂, and NH₃.

5. The method according to claim 1, wherein the forming the graphene thin layer comprises:
applying an expanded graphite dispersion to the resin substrate.

6. The method according to claim 5, further comprising:
filtering the expanded graphite dispersion; and
applying the filtered expanded graphite dispersion to the resin substrate by a wet transfer process.

7. The method according to claim 1, further comprising:
copper plating the resin substrate that has the graphene thin layer formed thereon.

8. The method according to claim 7, further comprising:
electroplating the resin substrate obtained after the copper plating using at least one metal selected from a group consisting of Ni, Cu, Sn and Zn.

9. The method according to claim 5, further comprising:
copper plating the resin substrate that has the graphene thin layer formed thereon.

10. The method according to claim 9, further comprising:
electroplating the resin substrate obtained after the copper plating using at least one metal selected from a group consisting of Ni, Cu, Sn and Zn.

11. The method according to claim 1, further comprising:
electroplating the graphene thin layer using at least one metal selected from a group consisting of Ni, Cu, Sn and Zn.

12. The method according to claim 5, further comprising:
electroplating the graphene thin layer using at least one metal selected from a group consisting of Ni, Cu, Sn and Zn.
